(19) United States
(12) Patent Application Publication
(10) Pub. No.: US 2022/0098418 A1
(43) Pub. Date: Mar. 31, 2022

(54) CURABLE COATING COMPOSITIONS AND ANTIMICROBIAL COATINGS MADE BY CURING SUCH COATING COMPOSITIONS

(71) Applicant: Green Theme Technologies Inc., Rio Rancho, NM (US)

(72) Inventors: Gary S. Selwyn, Albuquerque, NM (US); Chris B. Cooper, Albuquerque, NM (US); Aaron T. Caudill, Albuquerque, NM (US)

(21) Appl. No.: 17/488,458

(22) Filed: Sep. 29, 2021

Related U.S. Application Data
(60) Provisional application No. 63/085,327, filed on Sep. 30, 2020.

(51) Int. Cl. C09D 4/00; C08F 220/56; C08F 226/02; C08F 222/10; C08K 5/14; C08K 5/13; C08K 5/19; C08L 71/02; C08K 5/3432; D06M 16/00; D06M 15/267

(52) U.S. Cl. CPC C09D 4/00; C08F 220/56; C08F 226/02; C08F 222/105; C08K 5/14; C08L 2203/02; C08K 5/19; C08L 71/02; C08K 5/3432; D06M 16/00; D06M 15/267; C08K 5/13

(57) ABSTRACT

Antimicrobial/antiviral coatings are applied to substrates such as fabrics by applying and then curing a coating composition. The coating composition includes at least one free radical-curable monomer, at least one free radical initiator, and either or both of certain phenolic and/or menthol compounds and certain non-free radical-curable ammonium compounds.

This invention relates to coating compositions and antimicrobial/antiviral coatings made by curing such coating compositions.

The COVID-19 pandemic has brought to the forefront the need for effective means to combat the spread of infectious disease. As of September 2020, the pandemic has resulted in nearly 40 million confirmed cases and over one million deaths worldwide. Protective measures such as masks and sterile garments, once restricted almost exclusively to medical settings, are now used a daily basis by the general population in an attempt to reduce the spread of coronavirus. In addition, there is a desire to reduce or prevent the spread of pathogens through textiles in homes and in public facilities such as hospitals, hotels, offices, industrial environments, prisons and jails.

Although the virus can spread by various mechanisms such as direct transfer, one important means of virus transfer is through bodily fluids or aerosols, i.e., minute, virus-contaminated airborne droplets that can be expelled in the breath of humans. Personal protection gear such as masks and garments operate primarily as a mechanical barrier to the spread of the virus by trapping these fluids or aerosol droplets, and in that manner help to prevent the virus from spreading from person to person.

Greater efficacy could be achieved if the surface of the mask, garment or other textile was itself antimicrobial or antiviral and thereby by capable of killing or deactivating pathogens that impinge upon it. To this end, various topical treatments and coatings have been developed previously. However, those treatments and coatings have had significant shortcomings. Topical treatments and many coatings tend to be transient in nature, evaporating, washing or eroding away and thus providing only a short useful life. Especially for masks and air filters, there is concern that the anti-bacterial or anti-viral chemicals may break loose from the substrate and become airborne, presenting an inhalation hazard. Many coatings perform inadequately. Some coatings must be applied in thick layers to be effective. Some impart undesirable characteristics to the underlying substrate, such as poor breathability, stiffness or even odor. Many coatings are not laundry-durable and as such are useful only for single use items. Hospital scrubs and linens, for example, need to be used repeatedly and laundered between uses. Most coatings and topical treatments cannot withstand the laundering process.

Air circulation systems have been shown to promote the spread of the COVID-19 and other pathogens within buildings and other enclosed spaces. Evaporation of contaminated droplets in dry indoor air may lead to smaller droplets that do not settle by gravity and therefore become a means of airborne disease infection from HVAC recirculation system. Methods to combat the spread of pathogens by air circulation systems are highly desirable.

U.S. Pat. Nos. 9,487,912 and 10,542,756 describe textiles treated with an aqueous disinfecting treatment composition that includes a certain antifungal agents, one or more of a quaternary ammonium organosilane compound, a silver salt, poly-glucosamine, propiconazole, biocoated silver particles and polyhexamethylene biguanide, and a blocked isocyanate crosslinking agent. The treatment composition is applied to the textile and heat set to produce a mildly hydrophobic disinfectant coating.

The invention in one aspect is a coating composition comprising (i) one or more free radical-polymerizable monomers wherein the at least one free radical-polymerizable monomer constitutes 35-99.5% of the combined weights of (i), (ii), (iii) and (iv), (ii) at least one free radical initiator, and 0.25 to 40% by weight based on the combined weights of (i), (ii), (iii) and (iv), of a least one of (iii) and (iv), wherein (iii) is at least one phenolic compound having a molecular weight of up to 500 g/mol and/or one or more isomers of menthol and (iv) is at least one non-free radical-polymerizable ammonium compound having a molecular weight of up to 1000.

The invention is also an antimicrobial polymer produced by polymerizing a coating composition of the invention and a substrate having such a coating.

Component (i) of the coating composition is one or more free radical-polymerizable monomers. Such monomer(s) constitute 35 to 99.5% of the combined weights of components (i), (ii), (iii) and (iv). Component (i) monomers preferably have a formula molecular weight of up to 1000 g/mol, more preferably up to 750 g/mol or up to 500 g/mol.

Component (i) may be or include (i-a), at least one at least one free radical-polymerizable ammonium monomer having at least one (preferably only one) free-radical-curable carbon-carbon double bond and at least one ammonium group. The ammonium group is some embodiments is tertiary or, more preferably, quaternary, i.e., the nitrogen atom bearing the positive charge is bonded to three (in the tertiary case) or four (in the quaternary case) organic groups and at most one hydrogen atom. The nitrogen atom may be double bonded to an organic group, as is the case in which the ammonium group is pyridinium or substituted pyridinium.

The free-radical curable carbon-carbon double bond may form part of a acrylate or methacrylate group. Thus, in some embodiments, the ammonium monomer is an acrylate ester, methacrylate ester or acrylamide compound.

The ammonium monomer (i-a) in some embodiments includes at least one unsubstituted hydrocarbyl group having at least 6, preferably 6 to 18 or 6 to 12 carbon atoms. The hydrocarbyl group may be, for example, alkyl, alkylene, aromatic such as phenyl, alkyl-substituted phenyl, phenyl-substituted alkyl or phenyl-substituted alkylene.

Monomer (i-a) in some embodiments is one represented by the structure (I):

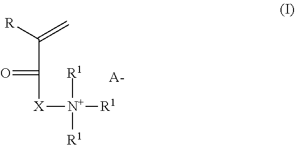

wherein R is hydrogen or methyl, X represents a linking group, each R¹ is independently hydrocarbyl having up to 18 carbon atoms, and A represents a monovalent counteranion. X in some embodiments is —NH—(CH₂)ₐ— or —O—(CH₂)ₐ— where a is a number from 1 to 24. In particular embodiments, a is at least 6, preferably 6 to 18 or 6 to 12, and/or at least one R¹ group is an alkyl and/or aromatic group having at least 6, preferably 6 to 18 or 6 to 12, carbon atoms, such as a C₆-C1₈ alkyl group, a phenyl group, an alkyl-substituted phenyl group, a benzyl group or an alkyl-substituted benzyl group.

Each R¹ may be independently linear, branched or cycloalkyl having 1 to 18 carbon atoms. If X lacks an alkylene chain of at least 6 carbon atoms, it is preferred that at least one R¹ group is an alkyl and/or aromatic group having at least 6, preferably 6 to 18 or 6 to 12, carbon atoms, such as an alkyl group, an aromatic group such as phenyl, an alkyl-substituted phenyl group, a phenyl-substituted alkyl group or phenyl-substituted alkylene group.

An R¹ group, if not an alkyl and/or aromatic group having at least 6 carbon atoms, may be, for example, a short-chain alkyl such as methyl, ethyl, n-propyl, isopropyl, n-butyl, t-butyl, sec-butyl and the like.

In certain embodiments, two or more R¹ groups together form a divalent radical, thereby producing a ring structure that includes the nitrogen atom bearing the charge.

A is a monovalent anion such as a halide ion, with chloride and bromide being preferred. Other useful monovalent anions include hydroxyl and monocarboxylate such as formate and acetate.

In other embodiments, the ammonium group of monomer (i-a) is pyridinium or substituted pyridinium. Such monomers include those represented by the structure (II)

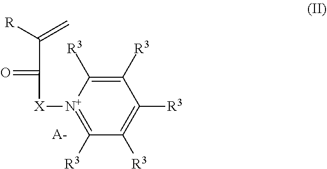

wherein R, X and A are as before, and each R³ is independently hydrogen or hydrocarbyl. X in some embodiments is —NH—(CH₂)ₐ— or —O—(CH₂)ₐ— where a is a number from 1 to 24. In particular embodiments, a is at least 3, preferably 3 to 18 or 3 to 12, and/or at least one R³ group includes a —(CH₂)_{b}— moiety in which b is having at least 3, preferably 3 to 18 or 3 to 12, carbon atoms in the chain.

Specific monomers (i-a) include one or more of a 3-acrylamidopropyl trimethyl ammonium salt, an N-(2-acryloyloxyethyl)-N-benzyl-N,N-dimethylammonium salt, a 12-methacryloyloxydodecylpyridinium salt, a methacryloyloxyundecylpyridinium salt, a methacryloxylethyldimethylcetylammonium salt, methacryloxylethyldimethyloctylammonium salt, a methacryloxydimethyldodecylammonium salt, and the like, in each case the counterion being monovalent, preferably chloride or bromide.

Monomers (i) may be or include (i-b) at least one monomer having at least two, preferably 2 to 20, 20 to 8 or 2 to 6, free radical-polymerizable carbon-carbon double bonds, which does not contain an ammonium group. A monomer of this type is sometimes referred to herein as a “crosslinking monomer” as it will produce crosslinking in the cured coating. Crosslinking is desirable in certain applications, in which durability, particularly laundry durability, is wanted in the treated fabric. Crosslinking is also desirable as an adhesive to prevent antimicrobial chemical moieties from breaking off from the substrate and becoming airborne when used in high velocity air filtration devices. Therefore, it is often desirable to include a crosslinking monomer (i-b) in the coating composition, especially in the preferred case in which the coating composition contains an ammonium monomer (i-a) that has only a single free radical-polymerizable carbon-carbon double bond, in order to produce a crosslinked coating. The crosslinking monomer may be the only free-radical polymerizing monomer in the coating composition.

The crosslinking monomer (i-b) preferably has a boiling temperature of at least 100° C., at least 125° C. or at least 150° C. All boiling temperatures in this specification are at one atmosphere pressure unless otherwise indicated. The crosslinking monomer preferably is a liquid at 22° C. The free-radical polymerizable group can be any that polymerizes in a free-radical polymerization, but preferably is an alkenyl, acrylate, methacrylate or chlorosilane group. Acrylate and/or methacrylate groups are most preferred.

Examples of crosslinking monomers (i-b) include polyacrylate or polymethacrylate compounds having 2 to 20, preferably 2 to 8 or 2 to 6 acrylate and/or methacrylate groups per molecule. Specific examples include acrylate and/or methacrylate esters of polyols having 2 to 50, 2 to 20 or 4 to 12 carbon atoms, such as 1,4-butanediol diacrylate, 1,6-hexanediol diacrylate, 1,8-octanediol diacrylate, cyclohexane dimethanol diacrylate, trimethylolpropane triacrylate, glycerin triacrylate, pentaerythritol tetraacrylate, dipentaerythritol tetraacrylate, dipentaerythritol pentaacrylate dipentaerythritol hexacrylate, the corresponding methacrylates, and the like. A mixture of dipentaerythritol pentaacrylate and dipentaerythritol hexaacrylate is particularly useful. So-called drying oils like linseed oil, safflower oil and tung oil are also useful crosslinkers.

Component (i) may be or include (i-c) one or more free radical-polymerizable monomers having up to 9 carbon atoms and exactly one free radical-polymerizable carbon-carbon double bond and which does not contain an ammonium group. Such monomer(s) preferably (i-c) do not bear either a positively or a negatively charged moiety. The free radical-polymerizable group of such a monomer (i-c) is preferably acrylate or methacrylate. Examples of such monomers include hexyl acrylate, butyl acrylate, hydroxyethyl acrylate, methyl acrylate, ethyl acrylate, hexyl methacrylate, butyl methacrylate, hydroxyethyl methacrylate, methyl methacrylate, ethyl methacrylate, styrene, ethylene benzene, chlorostyrene, and the like.

Component (i) may be or include (i-d) one or more free hydrophobic free radical-curable monomers having a boiling point that is equal to or greater than 100° C., exactly one free radical-polymerizable group per molecule, and at least one optionally fluorine-substituted hydrocarbyl group that has at least eight carbon atoms bonded directly or indirectly to the free radical-polymerizable group of the hydrophobic free radical-curable monomer. Examples of monomer (i-d) include one or more of 2-ethylhexyl acrylate, n-octyl acrylate, 2-ethylhexyl acrylate, n-octyl methacrylate, decyl acrylate, decyl methacrylate, lauryl acrylate, lauryl methacrylate, octadecyl acrylate, octadecyl methacrylate, 2-(perfluorohexyl)ethyl acrylate, 2-(perfluorooctyl)ethyl acrylate, 2-(perfluorodecyl)ethyl acrylate, 2-(perfluorohexyl)ethyl methacrylate, 2-(perfluorooctyl)ethyl methacrylate, lauryl methacrylate, stearyl methacrylate, 2-(perfluorodecyl)ethyl methacrylate, 2-(perfluorooctyl)ethyl trichlorosilane and vinyl naphthalene.

In particular embodiments, monomer (i) includes:

(A) one or more monomers (i-a) only;

(B) one or more monomers (i-a) that have only one free radical-polymerizable carbon-carbon double bond, and one or more monomers (i-b). In such a case monomer(s) (i-b) may constitute a major proportion of monomers (i), such as, for example, 50 to 95 mole-% or 60 to 85 mole-% thereof. In such embodiments, monomers (i-a) may constitute, for example, 5 to 50 mole-% or 15 to 40 mole-% of monomers (i). Alternatively, monomers (i-b) may constitute a minor proportion of monomers (i), such as 1 to 50 mole-% or 5 to 50 mole-% of monomers (i), and monomer(s) (i-a) may constitute, for example, 50 to 99 mole-%, 25 to 99 mole-% or 50 to 95 mole-% of monomers (i);

(C) one or more monomers (i-a) and one or more monomers (i-c). In such a case monomer(s) (i-c) may constitute, for example, 1 to 95 mole-% or 5 to 50 mole-% of monomers (i), and monomer(s) (i-a) may constitute, for example, 5 to 99 mole-% or 50 to 95 mole-% of monomers (i);

(D) one or more monomers (i-a) and one or more monomers (i-d). In such a case monomer(s) (i-d) may constitute, for example, 1 to 95 mole-% or 5 to 50 mole-% of monomers (i), and monomer(s) (i-a) may constitute, for example, 5 to 99 mole-%, 10 to 50 mole-%, 25 to 99 mole-%, or 50 to 95 mole-% of monomers (i);

(E) one or more monomers (i-a), one or more monomers (i-b) and one or more monomers (i-c). In such a case monomer(s) (i-a) in various embodiments may constitute, for example, 5 to 99 mole-%, 10 to 99 mole-%, 10 to 99 mole-% or 50 to 95 mole-% of monomers (i);

(F) one or more monomers (i-a), one or more monomers (i-b) and one or more monomers (i-d). In such a case monomer(s) (i-a) may constitute, for example, 5 to 99 mole-%, 10 to 99 mole-%, 25 to 99 mole-%, or 50 to 95 mole-% of monomers (i);

(G) one or more monomers (i-a), one or more monomers (i-c) and one or more monomers (i-d). In such a case monomer(s) (i-a) may constitute, for example, 5 to 99 mole-%, 10 to 99 mole-%, 25 to 99 mole-%, or 50 to 95 mole-% of monomers (i);

(H) one or more monomers (i-b) only;

(I) one or more monomers (i-b) and one or more monomers (1-c);

(J) one or more monomers (i-b) and one or more monomers (i-d);

(K) one or more monomers (i-b), one or more monomers (i-c) and one or more monomers (i-d);

(L) one or more monomers (i-c) only;

(M) one or more monomers (i-c) and one or more monomers (i-d); or

(N) one or more monomers (i-d) only.

Monomers (i) may constitute, for example, at least 25%, at least 40%, at least 50% or at least 60% of the combined weights of (i), (ii), (iii) and (iv), and as much as 99.5%, at much as 98%, at much as 95%, as much as 90%, as much as 80% or as much as 75% thereof.

The coating compositions contain component (ii), one or more free radical initiators. The free radical initiator preferably is heat- and/or UV-activated. Suitable free radical initiators include, for example, 1) acyl peroxides, such as acetyl or benzoyl peroxides, 2) alkyl peroxides, such as cumyl, dicumyl, lauroyl, or t-butyl peroxides, 3) hydroperoxides, such as t-butyl or cumyl hydroperoxides, 4) peresters, such t-butyl perbenzoate, 5) other organic peroxides, including acyl alkylsulfonyl peroxides, dialkyl peroxydicarbonates, diperoxyketals, ketone peroxides, or 1,1-Bis(tert-butylperoxy)-3,3,5-trimethylcyclohexane, 6) azo compounds, such as 2,2′-azobisisobutyronitrile (AIBN) or 2,2′-azobis(2,4-dimethylpentanenitrile), 4,4′-azobis(4-cyanovaleric acid), or 1,1′-azobis(cyclohexanecarbonitrile), 7) various tetrazines and 8) various persulfate compounds, such as potassium persulfate. Free radical initiators that are solids at 22° C. are preferred, as are those having a 10 hour half-life at a temperature of 60° C. or more. Those having a 1 minute half-life temperature of at least 100° C. are especially preferred. The free radical initiators in some embodiments may also have a half-life of at least one minute at 100° C. or a half-life of at least 6 minutes at 100° C.

The free radical initiators (ii) may constitute, for example, at least 0.25%, at least 1%, at least 3% or at least 5% of the combined weights of (i), (ii), (iii) and (iv), and as much as 20%, at much as 15%, as much as 10%, as much as 8% or as much as 7% thereof.

The coating composition includes either or both of (iii) one or more phenolic compounds having a molecular weight of up to 500 g/mol and/or one or more menthol isomers and (iv) one or more non-free radical-polymerizable ammonium compounds having a molecular weight of up to 1000.

Components (iii) and (iv) together may constitute 0.25 to 40% of the total weight of component (i), (ii), (iii) and (iv). Component (iii), when present, may, for example, constitute at least 0.25%, at least 0.5% or at least 1%, at least 3% or at least 5% on the same basis, and may constitute, for example, up to 30%, up to 25% or up 20%, again on the same basis. Component (iv), when present, may, for example, constitute at least 0.25%, at least 0.5% or at least 1%, at least 3% or at least 5% on the same basis, and may constitute, for example, up to 20%, up to 15% or up 10%, again on the same basis. Components (iii) and (iv) together in some embodiments constitute at least 5% at least 10% or at least 15% and up to 35%, up to 30% or up to 25% on the same basis.

Component (iii) are compounds in some embodiments do not contain any carbon-carbon unsaturation that polymerizes in the presence of free radicals, and contains at least one hydroxyl group bonded directly to an aromatic ring carbon atom. Examples of such compounds include phenol, cresol, o- and or p-phenyl phenol, stilbene, rhapontin, resveratrol, pinosylvin, caffeic acid, caffeic acid 1,1-dimethylallyl ester, chicoric acid, cinnamyl-3,4-dihydroxy-α-cyanocinnamate, 2,4-dihydroxycinnamic acid, ethyl 3,4-dihydroxycinnamate, chlorogenic acid, CU-CPT22 acid, butyl gallate, ethyl 3,5-dihydroxybenzoate, 3,4-dihydroxy-benzoic acid methyl ester, 2,4-dihydroxy-3,6-dimethylbenzoic acid, isopropyl 3,4,5-trihydroxybenzoate, methyl 3,5 dihydroxybenzoate) acids, cardamonin, dihydromyricetin, diosmin, epigallocatechin gallate, myricetin, myricitrin, quercetin 3-β-D-glucoside, rutin, silibinin, taxifolin, wedelolactone, baicalein, 3′,5′-dihydroxyflavone, 5,7-dihydroxy-4-phenylcoumarin, 5,7-dihydroxy-4-propylcoumarin, 5,7-dihydroxy-4-methylcoumarin, 5,8-dihydroxy-1,4-naphthoquinone, 2,3-dichloro-5,8-dihydroxy-1,4-naphthoquinone, thymol (2-isopropyl-5-methylphenol), carvacrol (2 isopropyl-6-methylphenol), 2-benzyl-4chlorophenol. Other useful compounds (iii) include one or more isomers of menthol (5-methyl-2-(propan-2-yl)cyclohexan-1-ol)), including (+)-menthol, (+)-isomenthol, (+)-neomethyol, (+)-neoisomenthol, (−)-menthol, (−)-isomenthol, (−)-neomenthol and (−)-neoisomenthol Mixtures of any two or more of the foregoing are useful.

The non-free radical-polymerizable ammonium compound having a molecular weight of up to 1000 (iv) has at least one positively charged nitrogen atom and may have two or more thereof. It does not contain an unsaturated group that undergoes free radical polymerization; in particular it does not contain any aliphatic carbon-carbon double or triple bonds. This compound preferably contains at least one alkyl or alkylene group that has a linear chain of at least 8, preferably 8 to 20 or 12 to 20, carbon atoms.

Among the suitable non-free radical polymerizable ammonium compounds (iv) are those represented by any of structures III, IV, V, VI and VII:

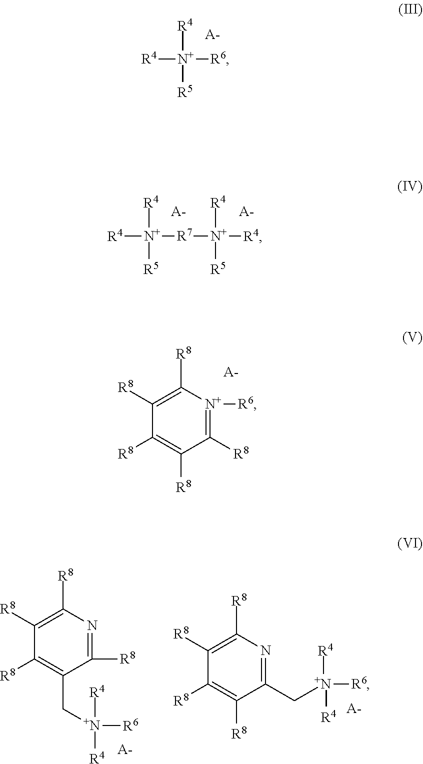

wherein:

each A is as before;

each R⁴ is independently alkyl (preferably C₁₋₄ alkyl and most preferably methyl), provided that any two R⁴ groups may together form a divalent alkylene group;

each R⁵ is independently alkyl (preferably C₁₋₄ alkyl, especially methyl), phenyl, substituted phenyl, benzyl or ring-substituted benzyl;

each R⁶ is an unsubstituted or substituted alkyl group having at least one unbroken chain of 8 or more, preferably 8 to 20 or 12 to 20, consecutive aliphatic carbon atoms;

R⁷ is an unsubstituted or substituted alkylene group having at least one unbroken chain of 8 or more, preferably 8 to 20 or 12 to 20 consecutive aliphatic carbon atoms; and

each R⁸ is independently hydrogen, hydroxyl substituted or unsubstituted alkyl, alkoxyl, halogen, provided that any two R⁸ groups may together form an unsubstituted or substituted divalent alkylene group.

Specific examples of non-free radical-polymerizable ammonium compound having a molecular weight of up to 1000 include a C₈₋₁₈ alkyl dimethyl benzyl ammonium salt, a dialkyldimethyl ammonium salt wherein the alkyl groups have 8 to 18 carbon atoms; a benzyl dimethyl alkyl ammonium salt in which the alkyl group has 8 to 18 carbon atoms; a 1,1′-decane-1,10-diylbis(4-amino-2-methylquinolinium) decyl]-2-methyl-4-quinolin-1-iumamine salt (dequalinium) a (benzyl-dimethyl-[3-(tetradecanoylamino)propyl]azanium salt (miramistin), an N-((5-Acetoxy-4,6-dimethylpyridin-3-yl)methyl)-N,N-dimethyloctan-1-aminium salt, a N-((5-Acetoxy-4, 6-dimethylpyridin-3-yl)methyl)-N,N-dimethyldodecan-1-aminium salt, a N-((5-Acetoxy-4,6-dimethylpyridin-3-yl)methyl)-N,N-dimethyloctadecan-1-aminium salt, a 5-((Octyldimethylammonio)methyl)-3-hydroxy-2,4-dimethylpyridin-1-ium salt, a 5-((Dodecyldimethylammonio)methyl)-3-hydroxy-2,4-dimethylpyridin-1-ium salt and a 5-((Dimethyl(octadecyl)ammonio)methyl)-3-hydroxy-2,4-dimethylpyridin-1-ium salt, in which the counterions are monovalent, being preferably monocarboxylic acid, hydroxyl, chloride or bromide.

Other suitable non-free radical-polymerizable ammonium compounds include protic acid salts of compounds having at least one —NH—C(═NH)—NH— moiety, such as, for example, a chlorhexidine salt of a protic acid. The protic acid may be a strong acid such as HCl or a weak acid such as acetic or gluconic acid.

The coating composition may contain various optional ingredients, any or all of which can be omitted.

Water, if present at all, preferably constitutes no more than 50%, more preferably no more than 30% or no more than 20% of the total weight of the coating composition.

The coating composition may contain one or more carriers. Useful carriers or mixtures of carriers are liquid at 22° C. or else are materials that are solid at 22° C. but-have a melting temperature of 100° C. or less, preferably 50° C. or less. The carrier preferably also has a boiling temperature of at least 100° C., more preferably at least 125° C. and still more preferably at least 150° C. The carrier contains no free-radical-polymerizable groups. Examples of useful carriers are (i) aliphatic monoalcohols or aliphatic monocarboxylic acids having 14 to 30 carbon atoms; (ii) esters of a fatty acid and a fatty alcohol, the ester having 18 to 48 carbon atoms, preferably 20 to 36 carbon atoms; (iii) a polyether having one or more hydroxyl groups, such as a polypropylene glycol or polyethylene glycol; (iv) a polysiloxane, which can be linear, branched or cyclic; (v) a polysiloxane-poly(alkylene glycol) copolymer; (vi) a wax, such as a polyethylene wax, bees wax, lanolin, carnauba wax, candelilla wax, ouricury wax, sugarcane wax, jojoba wax, epicuticular wax, coconut wax, petroleum wax, paraffin wax and the like, especially one having a melting temperature of greater than 22° C., preferably greater than 35° C. but no greater than 100° C., especially no greater than 50° C.; (vii) a fluoropolymer, (viii) solid vegetable and/or animal oils or fats; (viii) another organic oligomer or polymer having a pure phase melting or softening temperature up to 100° C., (ix) various plasticizers or (x) various low molecular weight (up to 250 g/mol formula weight) hydrophilic compounds such as citric acid. A carrier of particular interest is a hydrophilic polymer having at least one oxyethylene chain of 3 to 200 oxyethylene units and an oxyethylene content of at least 50% by weight of the hydrophilic polymer, which may constitute, for example, 1 to 30 weight-5 of the coating composition. Such a hydrophilcpolymer may be a polyethylene glycol having a number average molecular weight of 180 to 3000.

The coating composition may also include one or more promoters or activators for a polymerization catalyst and/or free radical initiator. Metal salts such as iron or vanadium salts and manganese ions or manganese are examples of such promoters.

In some embodiments the coating composition further contains a fragrant essential oil or extract such as an oils or extract of peppermint, wintergreen, spearmint, almond, basil, citronella, cinnamon bark, lemon eucalyptus, cedar wood, clove, cypress, eucalyptus, frankincense, ginger, orange, lemon, lime, jasmine, spruce, juniper, hyssop, lemongrass, myrtle, lemon myrtle, myrrh, nutmeg, oregano, patchouli, pine, rosemary, rose, sandalwood, tea, star anise, sage or thyme. For example, such an essential oil or extract may be present, if present at all, in an amount of 0.1 to 5% of the combined weights of (i), (ii), (iii) and (iv). The presence of such an essential oil or extract is especially desirable in applications such personal protection equipment, particularly face coverings, but may also have use with air filters.

Antimicrobial/antiviral coatings are made by applying the coating composition to a substrate and polymerizing the monomer(s) (i) to form a polymeric coating adherent to the substrate. At least a portion of components (iii) and (iv) have been found to remain with the polymer, being dissolved, sorbed onto and/or mechanically trapped within the polymer structure. This aids in keeping components (iii) and (iv) from being washed off, rubbed off, or blown off from the treated substrate.

In the broadest sense, the substrate can be any material that is capable of being carried through the coating process and the polymerization process. Fibrous substrates are particularly useful. By “fibrous”, it is meant that a surface of the substrate to which the coating composition is applied is made up of or includes fibers of at least one type. The fibers define interstitial void spaces in which air is entrapped and into which the applied coating composition can penetrate.

The substrate preferably is a porous fabric characterized in having, prior to coating in accordance with the invention, an air permeability of at least 25 cubic foot/minute/square foot as measured according to ASTM D737, using a SDL Atlas M021A or equivalent instrument and a 38 cm² test area. More preferably, the porous fabric has an air permeability of at least 50, at least 75, at least 100 or at least 130 cubic feet/minute/square foot. The air permeability of the porous fabric may be any higher value, such as up to 1250 cubic feet/minute/square foot, as may be the case for air filters and coverings for fan blades, for example.

The fibers may be, for example, woven, knitted, entangled, knotted, felted, glued or otherwise formed into a fabric, non-woven or textile having sufficient mechanical integrity to be carried through the process of the invention. Such a fabric includes fibers that may be, for example, a natural fiber such as cotton, hemp, wool, linen, silk, tencel, rayon, bamboo, cellulose and the like, or a synthetic fiber such as nylon, aramid, polypropylene, polyester (including PET), polyacetate, polyacrylic, polylactic acid, cellulose ester or other fiber and blends of any two or more of the above. It may a smooth or fleeced fabric and it may contain a stretchable fiber, such as Elastane, Lycra, or Spandex. It may also be a meshed fabric, with as much as 75% open space.

Fabrics in the form of flexible sheet goods are preferred substrates, although finished goods such as shoes, masks and complete articles of clothing can also be treated in this manner. When the substrate is in the form of a sheet, it should have a thickness of no greater than about 12 mm, and preferably has a thickness of no greater than 10 mm or no greater than 8 mm. The substrate can have any smaller thickness provided it has enough mechanical integrity to be conducted through the process. The curable composition in some embodiments is applied onto textile roll goods that may have widths of 100 mm or more, such as 300 mm up to 7 meters or more.

In other embodiments, the substrate may be coated on one side as is the case, for example, with masks and air filters such as furnace filters and air transportation filters that may be made from spunbond or meltblown nonwovens. The substrate fabric may be a nonwoven or a cellulosic material such as paper, tissue paper or cardboard and the like, including those as are commonly used for air filtration purposes.

In some embodiments, the substrate has at least one hydrophobic surface, either because the substrate is intrinsically hydrophobic or because of an applied hydrophobic coating. The substrate may be a fabric of which one or both of the major surfaces are hydrophobic. A hydrophobic surface for purposes of this invention is one on which water produces an advancing contact angle of at least 90 degrees as measured by ASTM D7334-08 or equivalent test. The hydrophobic surface may be an inherent feature of the material of construction of the substrate and/or may be produced by applying a hydrophobic coating on at least one surface of the substrate. In some cases, one side of the substrate may be hydrophilic whereas the other side may be hydrophobic. Such a substrate can be produced, for example, by treating one or both sides of the fabric to have different properties.

In some embodiments, the hydrophobic coating is a coating as described in WO 2015/127479, U.S. Pat. Nos. 9,487,912 and/or 10,542,756, all incorporated by reference in their entirety. In a particular embodiment, the substrate has one at least one surface a coating of a hydrophobic polymer produced by curing a coating composition comprising at least one of a) and b), wherein

a) is at least one free-radical-curable monomer having exactly one polymerizable group per molecule, the free-radical-curable monomer having at least one hydrocarbyl group that has at least eight carbon atoms bonded directly or indirectly to the polymerizable group, wherein the hydrocarbyl group may be nonfluorinated, partially fluorinated or perfluorinated, the free-radical-curable monomer having a boiling temperature equal to or greater than 100° C.,

and b) is at least one crosslinking monomer having at least two free-radical-curable polymerizable groups and a boiling temperature equal to or greater than 100° C.;

and such a coating composition further includes a free radical initiator, wherein the coating composition is a liquid at 22° C. or a suspension of one or more solids in a liquid phase at 22° C. Such a hydrophobic coating may or may not include a silicone oil; however it is preferred to omit a silicone oil when the coated substrate is intended to hold an electrostatic charge, as is the case, for example, with certain air filters.

For example, the substrate in some embodiments is a fabric coated on one or both sides with such a hydrophobic polymer. The antimicrobial coating of this invention may be applied on top of the hydrophobic polymer, on one or both sides of the fabric. If the hydrophobic polymer coating is present on both sides of the fabric, the antimicrobial polymer may be applied on top of the hydrophobic polymer on only one side, to produce a fabric having a hydrophobic surface and an opposing antimicrobial surface, or on both sides produce two antimicrobial surfaces. Alternatively, the hydrophobic polymer may be applied to only one side of the fabric and the antimicrobial coating to the opposing side, again producing a coated fabric with a hydrophobic coating on one surface and an antimicrobial coating on the opposing surface.

The coating composition of the invention can be applied to the substrate by any of many convenient methods, such as by rolling, gravure coating, brushing, spraying, immersing the textile into the composition, applying a puddle and scraping the composition into the textile using, for example, and air knife or doctor blade, and the like. Less preferred immersion methods can be used when the curable coating composition contains large amounts of a liquid carrier. Immersion methods are generally followed by compressing the coated fabric to remove excess fluid before curing.

A preferred coating weight is 1 to 70 g/m², especially 2 to 50 g/m² or 3 to 15 g/m² per side to which the coating composition is applied. For example, for heavier substrates (especially porous fabrics), the coating weight may be, for example, 6 to 25 g/m², whereas for lighter substrates (especially porous substrates), the coating weight may be 1.5 to 15 or 1.5 to 10 g/m² per side. Higher coating weights can be applied using two or more chemical transfer apparatuses in series or by passing the substrate through a chemical transfer apparatus multiple times.

In general, polymerization is performed by subjecting the coated substrate to a source of free radicals. Free radicals can be provided in several ways. If the coating composition contains a heat-activated free-radical initiator, free radicals can be provided by heating the coated substrate to a temperature at which the free radical initiator generates free radicals, as discussed more fully below. Heating of the coated substrate may be done in an oven (such as by passing the coated substrate through the oven on a moving platform or tenter frame), by contacting the coated substrate with a heated surface such as one or more heated rollers, by blowing hot gas onto or through the coated substrate or by alternative means such as exposing the coated substrate to ultraviolet or microwave energy, by exposing the coated substrate to a low temperature plasma or by any combination thereof.

When using a thermal curing process as just described, preferred curing temperatures are in general from 100 to 210° C., preferably 115 to 190° C. and more preferably 130 to 180° C. When a polypropylene substrate is used, the preferred curing temperature is 100-110 C to avoid softening of the fiber. It is generally advantageous in such thermal curing processes to heat the coated substrate to the elevated temperature for a time sufficient to decompose at least 50 mole-percent, more preferably at least 75 mole-percent or at least 85 mole-percent, of the free radical initiator to form free radicals. The temperature and time needed is related to the decomposition rate constant for the particular free radical initiator. Additionally, the time required is inversely related to temperature, such that lower times are needed to attain a given amount of decomposition of the free radical initiator as the temperature is increased.

In another curing approach, the coated substrate may be contacted with a plasma that may be at approximately atmospheric pressure or may be a vacuum-based plasma. An applied plasma preferably contains no more than 1 mole percent, more preferably no more than 0.1 mole percent of oxygen (02). The plasma may be heated, for example, to temperatures as describe above with respect to the thermal curing method, or may be at a lower temperature. The plasma generates free radicals in the gas phase of the plasma. These radicals impinge the coated surface of the substrate, triggering the polymerization process.

In still other embodiments, the coated substrate may be exposed to ultraviolet radiation, e-beam radiation or ionizing radiation source to produce free radicals. Alternatively, the treated substrate can be contacted with an additional component, not present in the curing composition, such as a spray of hydrogen peroxide, to generate free radicals for the curing reaction.

The polymerization may be performed in a low oxygen environment, at or above atmospheric pressure, as described, for example, in WO 2015/127479.

The polymerization is continued until such time as a room temperature solid polymer is produced. Complete conversion of monomer to polymer may be accomplished during the polymerization step, but doing so is not necessary, and less than 100% conversion may be beneficial. Thus, for example, polymerization may be continued until the conversion of monomer(s) is at least 50 mole-percent or at least 75 mole-percent and up to 98 mole-percent, up to 95 mole-percent, up to 90 mole-percent or up to 85 mole-percent.

The coated substrate is useful in any environment or application in which antimicrobial properties are desired. By “antimicrobial” it is meant that the coated substrate kills or inhibits the growth of one or more microorganisms, the microorganism being, for example, a bacterial, a fungus, a virus, a protist or other type.

Textiles having an antimicrobial coating of the invention are useful, for example, as clothing, particularly for use in medical and/or sterile environments (such as hospital scrubs or biological laboratory protective clothing), bed linens (sheets, pillowcases, etc., again especially for use in medical, nursing or other care facilities or other sterile environments), shoe covers, masks and other protective articles. Such articles can be disposable (single use) items or multi-use items that are to be laundered after use and then re-used.

When the article is to be laundered and re-used, the coating composition preferably is crosslinked, i.e., at least one of the monomers (i) present in the coating composition has at least two free radical-polymerizable carbon-carbon double bonds which polymerize during the polymerization step to produce a three-dimensional crosslinked polymeric structure. The antimicrobial coating composition for such articles may contain, for example: at least 50 weight-% of one or more monomers (i-a) that has only one free radical-polymerizable carbon-carbon double bond, 5 to 25 weight-% of one or monomers (i-b), the free radical initiator, 0.25 to 10 weight % of component (iii) and optionally 0.25 to 10 weight-% of component (iv), based on the combined weights of components (i), (ii), (iii) and (iv).

In addition, it has been found that the antimicrobial coating of the invention in many cases produces a highly hydrophilic surface on the fabric, particularly when it contains one or more ammonium groups. When such a coated fabric is laundered in water (or otherwise thoroughly wetted) and then dried in hot air such as in a conventional clothes dryer, the fabric tends to clump or even tear as the hydrophilic surface coating tends to adhere to itself during the laundering and/or drying process. Very surprisingly, this problem is alleviated when the fabric is hydrophobic by itself, or more preferably has a hydrophobic coating, such as a hydrophobic coating as described in WO 2015/127479, U.S. Pat. No. 9,487,912 and/or U.S. Pat. No. 10,542,756. The hydrophobic coating may be applied to either or both sides of the fabric. The antimicrobial coating of the invention may be applied on top of the hydrophobic coating on at least one side of the fabric. Alternatively, the hydrophobic coating may be applied to one side of the fabric, and the antimicrobial coating to the other side. The combination of both coatings allows the fabric to be laundered without the hydrophilic coating adhering to itself and forming clumps or producing tears or other defects. The antimicrobial coating should be crosslinked as well to improve laundry durability.

When used on substrates that do not require laundering, such as disposable or single-use items, it is not necessary that the antimicrobial coating be crosslinked, although it may be. The antimicrobial coating composition in such a case may contain, for example,

1. at least 50 weight-% of one or more monomers (i-d), no more than 5 weight-% and in some cases none of monomers (i-b), the free radical initiator, 0 t 10 weight-% or 0.25 to 10 weight-% of component (iii) 0 to 10 weight-% of component (iv), based on the combined weights of components (i), (ii), (iii) and (iv); or

2. at least 50 weight-% of one or more monomers (i-b), no more than 5 weight-% each, and in some cases none, of monomers (i-a) and (i-d), the free radical initiator, 0 to 10 weight-% or 0.25 to 10 weight-% of component (iii) and 0 to 10 weight-% of component (iv), based on the combined weights of components (i), (ii), (iii) and (iv).

A coated substrate of the invention may be another type of personal protection article, such as a facemask or other face covering; protective gloves, gowns, fabric boots; a hood; a hair net and similar articles.

A coated substrate of the invention may be, for example, a bandage or a sorbent pad for absorbing blood and other bodily fluids that may be or become contaminated with microbes.

A coated substrate of the invention may be a single use antiseptic wipe or towel, the substrate in such a case being a woven fabric, or a non-woven fabric such as a melt-blown or spunbonded fabric.

A coated substrate of the invention may be a component of an air circulation system for a building, vehicle (of any type) or other enclosed space. A antimicrobial coating of the invention may be applied to the blades of a fan in such an air circulation system to capture, kill and/or inhibit growth of air-borne microbes. Examples include the blades of ceiling fans, window fans, humidifiers, air purifiers, air conditioners, floor fans and HVAC blowers.

In a particular embodiment, the coated substrate is a fabric covering for a fan blade, particularly for low speed fans such as residential or commercial ceiling fans. Such a fabric covering is adapted to fit onto or around such a fan blade and be secured thereto, preferably by a detachable means so the fabric covering can be removed and replaced easily. The substrate in such a case may have an airflow of at least 300 or at least 1000 cubic feet/minute/square foot as measured according to ASTM D737, using a SDL Atlas MO21A or equivalent instrument and a 38 cm² test area. Suitable substrates include cotton fabrics and polyester fabrics. Such a polyester fabric may by a spunbond or melt-blown non-woven. The antimicrobial coating composition may contain, for example:

1. at least 5, at least 10, at least 20 or at least 50 weight-% of one or more monomers (i-a), the free radical initiator, 0 to 10 weight-% or 0.25 to 10 weight-% of component (iii) and optionally 0.25 to 30 weight-% or 0.25 to 10 weight-% of component (iv), based on the combined weights of components (i), (ii), (iii) and (iv);

2. at least 5, at least 10, at least 20 or at least 50 weight-% of one or more monomers (i-b), no more than 25 weight-% or no more than 5 weight-% and in some cases none of monomers (i-a), the free radical initiator, 0 to 10 weight-% or 0.25 to 10 weight-% of component (iii) and 0.25 to 30 weight-% or 0.25 to 10 weight-% of component (iv), based on the combined weights of components (i), (ii), (iii) and (iv);

3. at least 50 weight-% of one or more monomers (i-d), no more than 25 weight-%, or no more than 5 weight-% and in some cases none of monomers (i-a), the free radical initiator, 0 to 10 weight-% or 0.25 to 10 weight % of component (iii) and 0.25 to 30 weight-5 or 0.25 to 10 weight-% of component (iv), based on the combined weights of components (i), (ii), (iii) and (iv).

Other internal or external components of an HVAC or other air moving system that comes into contact with the moving air may be coated with an antimicrobial coating of the invention. These components may include, for example, the internal surfaces of air ducts and blowers; exhaust ducts; vents, air filters and air returns.

In another particular embodiment, the substrate is an air filter for such an HVAC or other air moving system, which has an antimicrobial coating of the invention on one or both opposing major surfaces. Such an air filter preferably has a hydrophobic surface and an opposing surface coated with the antimicrobial coating of the invention. The air filter may be, for example, a nonwoven fabric such as a melt-bonded or spun-bonded polypropylene or a glass fiber mat. The hydrophobic surface may be a coating of a hydrophobic polymer on one or both sides of the nonwoven fabric, or may be an innate property of the material of construction of the filter.

The substrate for an air filter (electrostatic or otherwise) may be, for example, a polypropylene fabric (which may be, for example, woven, knitted, spunbond or melt-blown fabric) having an airflow of at least 300 or at least 1000 cubic feet/minute/square foot as measured according to ASTM D737, using a Textest FX 3300 instrument and a 38 cm² test area. The antimicrobial coating composition for an air filter may contain, for example:

1. at least 50 weight-% of one or more monomers (i-b), no more than 25 weight-% or no more than 5 weight-% and in some cases none of monomers (i-a), the free radical initiator, 0 to 10 weight-% or 0.25 to 10 weight % of component (iii) and preferably no more than 0.1 weight-% of component (iv), based on the combined weights of components (i), (ii), (iii) and (iv); or

2. at least 50 weight-% of one or more monomers (i-d), no more than 25 weight percent or no more than 5 weight-% and in some cases none of one or more monomers (i-a), the free radical initiator, 0 to 10 weight-% or 0.25 to 10 weight % of component (iii) and preferably no more than 0.1 weight-% of component (iv), based on the combined weights of components (i), (ii), (iii) and (iv).

The coating composition for an air filter preferably contains no more than 5 weight percent of a silicone oil, which may be absent.

In another particular embodiment, the invention is an electrostatic air filter for an HVAC or other air moving system. The multilayer air filter includes a first porous electrostatic filter layer and a second, antimicrobial filter layer that has an antimicrobial coating of the invention on one or both sides. The porous covering can take the form of a casing or bag having an opening along one side, which casing or bag is adapted to receive the air filter, and is easily detachable therefrom and replaceable. The electrostatic and antimicrobial filter layers are not in electric communication, being spaced apart with an insulating layer (which may be air or an insulating solid) interposed between them, so an electrostatic charge applied to the electrostatic filter layer is not dissipated by the antimicrobial layer, which tends to be electrically conductive if it contains ammonium groups. Such an antimicrobial filter layer may be changed more or less frequently that the accompanying dust filter. Suitable coating compositions for the second, antimicrobial filter layer may contain, for example:

1. at least 5 weight-%, at least 20 weight-% or at least 50 weight-% of one or more monomers (i-a), the free radical initiator, 0.25 to 10 weight % of component (iii) and optionally 0.25 to 10 weight-% of component (iv), based on the combined weights of components (i), (ii), (iii) and (iv);

2. at least 50 weight-% of one or more monomers (i-b), no more than 25 weight-% or no more than 5 weight-% and in some cases none of monomers (i-a), the free radical initiator, 0.25 to 10 weight % of component (iii) and 0.25 to 10 weight-% of component (iv), based on the combined weights of components (i), (ii), (iii) and (iv);

3. at least 50 weight-% of one or more monomers (i-d), no more than 25 weight-% or no more than 5 weight-% and in some cases none of monomers (i-a), the free radical initiator, 0.25 to 10 weight % of component (iii) and 0.25 to 10 weight-% of component (iv), based on the combined weights of components (i), (ii), (iii) and (iv).

The following examples are provided to illustrate the invention, not to limit the scope thereof. All parts and percentages are by weight unless otherwise indicated.

### EXAMPLES 1-6 AND COMPARATIVE SAMPLES A-C

Comparative Sample A is an untreated non-woven polypropylene HVAC air filter fabric having an airflow of 1000 cubic feet/minute/square foot. This same fabric is coated to produce Comparative Samples B and C and Examples 1-6.

To produce Comparative Sample B, a sample of the fabric is coated on each side with a mixture of 47% monomers (C14-18 alkyl acrylates, a polyacrylate crosslinker), 47% 10 centistoke polydimethylsiloxane oil and 6% lauryl peroxide. The coating weight on each side is about 8 g/m². This coating composition is cured for 30 minutes at 100° C. under a nitrogen atmosphere at 500 psi (3.45 MPa) gauge pressure to produce a hydrophobic, water-repellant coating on each side of the fabric sample.

Comparative Sample C is made in the same manner as Comparative Sample B, except the coating mixture in addition contains 10%, based on the weight of the monomers, of cupric oxide particles. Total coating weight is about 21 g/m².

Examples 1-4 and 6 are produced by first applying a hydrophobic, water repellant coating as described for Comparative Sample A to only one side of the fabric. The coating weight is about 4-8 g/m². An antimicrobial coating composition of the invention is applied to the opposite side at a weight of 4-8 g/m² and cured to produce an antimicrobial polymeric coating.

Example 5 is produced by applying an antimicrobial coating of the invention to one side of an untreated sample of the non-woven polypropylene fabric, at a coating weight of about 8.6 g/m².

The antimicrobial coating compositions used in Examples 1-6 are as indicated in Table 1. The antimicrobial coating compositions are cured at 135° C. for 30 minutes under nitrogen at 500 psi (3.45 MPa) gauge pressure, with venting to permit water vapor to escape, to produce the antimicrobial coating. The fabric is sterilized under these conditions. It is wrapped in a heat-treated, sterile aluminum foil to maintain its sterile condition for antiviral testing.

TABLE 1

| | Parts By Weight | | | | | |
|---|---|---|---|---|---|---|
| Ingredient | Ex. 1 | Ex. 2 | Ex. 3 | Ex. 4 | Ex. 5 | Ex. 6 |
| 75% N-(2-Acryloyloxyethy)- | 100 | 100 | 100 | 100 | 100 | 100 |
| N-benzyl-N,N- | | | | | | |
| dimethylammonium | | | | | | |
| chloride in water | | | | | | |
| Pentaacrylate¹ | 20 | 20 | 20 | 20 | 20 | 20 |
| Lauryl Peroxide | 5 | 5 | 5 | 5 | 5 | 5 |
| 2-Phenyl Phenol | 30 | 30 | 0 | 0 | 0 | 0 |
| Thymol | 0 | 0 | 30 | 30 | 30 | 30 |
| Benzyl dimethyl stearyl | 10 | 10 | 0 | 0 | 10 | 10 |
| ammonium chloride | | | | | | |
| hydrate | | | | | | |
| Didecyldimethylammonium | 0 | 0 | 10 | 10 | 0 | 0 |
| bromide | | | | | | |
| 200 Mₙ Polyethylene glycol | 0 | 10 | 0 | 10 | 0 | 10 |

¹A commercial mixture of dipentaerythritol penta- and hexaacrylates with average formula molecular weight of 524.51 g/mol.

Antiviral testing is performed by placing a small sample of each fabric sample in a 24-well plate. For Examples 1-6, the fabric is placed with the side having the antimicrobial coating on the upper surface. 1×10⁵ PFU of live SARS-CoV-2 virus (isolate USA-WA1/2020) is added to the upper surface of the coated fabric. The inoculated samples are held at room temperature for 2, 8 and 24 hours. 300 microliters of a growth medium are added to each well. After 30 minutes, the growth medium is collected and added to Dye Engleys Neutralizing Broth (Millapore Sigma) at a 1:10 volume ratio and held for 15 minutes at room temperature. A plaque assay is then run to measure the amount of virus. For comparison, a control with no fabric sample and in the Dye Engleys Neutralizing Broth without a fabric sample. Duplicate runs are performed in each case, with the average of the two runs being as indicated in Table 2.

TABLE 2

| | Assay (PFU) | | |
|---|---|---|---|
| Sample | 2 hr | 8 hr | 24 hr |
| Virus Control | 83,000 | 8300 | 4950 |
| DE plus virus | 49,500 | 6600 | 3300 |
| control | | | |
| Comp. A | 198,000 | 8300 | 1430 |
| Comp. B | 83,000 | 19,800 | 660 |
| Ex. 1 | 0 | 0 | 0 |
| Ex. 2 | 0 | 0 | 0 |
| Ex. 3 | 0 | 0 | 0 |
| Ex. 4 | 0 | 0 | 0 |
| Ex. 5 | 0 | 0 | 0 |
| Ex. 6 | 83 | 0 | 0 |
| Comp. C | 66,000 | 2650 | 264 |

As can be seen from the data in Table 2, each of Examples 1-5 completely eliminated the virus after only two hours. Example 6 completely eliminated the virus after 8 hours. All performed significantly better than Comp. C, which contains commercially available antimicrobial particles.

### EXAMPLES 7-10

Woven polyester fabric samples are coated on each side with a mixture of 47% monomers (C14-18 alkyl acrylates, a polyacrylate crosslinker), 47% 10 centistoke polydimethylsiloxane oil and 6% lauryl peroxide. The coating weight on each side is 10-15 g/m². This coating composition is cured for 30 minutes at 100° C. under a nitrogen atmosphere at 500 psi (3.45 MPa) gauge pressure to produce a hydrophobic, water-repellant coating on each side of the fabric sample.

The samples are then coated again on each side with 8-10 g/m² of an antimicrobial coating composition of the invention to produce Examples 7-10. The coating compositions are as set forth in Table 3. The antimicrobial coating composition is cured on the surface of the fabric at 135° C. for 30 minutes under nitrogen at 500 psi (3.45 MPa) gauge pressure, with venting to permit water vapor to escape, to produce the antimicrobial coating.

TABLE 3

| | Parts by Weight | | | |
|---|---|---|---|---|
| Ingredient | Ex. 7 | Ex. 8 | Ex. 9 | Ex. 10 |
| N-(2-Acryloyloxyethyl)- | 100 | 100 | 100 | 100 |
| N-benzyl-N,N- | | | | |
| dimethylammonium | | | | |
| Chloride | | | | |
| Pentaacrylate¹ | 20 | 20 | 20 | 20 |
| T-Butyl Peroxide | 5 | 5 | 5 | 5 |
| Benzyl dimethyl stearyl | 10 | 0 | 10 | 10 |
| ammonium chloride | | | | |
| hydrate | | | | |
| 2-Phenyl phenol | 0 | 10 | 10 | 30 |

¹See note 1, Table 1.

Antibacterial properties of each of Examples 7 and 9 are evaluated as follows: a B. thailandensis culture is diluted to an estimated concentration of 1×10⁵ to 3×10⁵ CFU/mL in a suspension medium. 0.8 grams of fabric sample are cut into 3.8 cm squares; 10 squares are placed into a sterile jar. 1 mL of the B. thailandensis culture is added to the jar and the fabrics incubated at 37° C. for 0 hours (as a control) or 4 hours. The fabric samples are then neutralized by adding Dey-Engly buffer and serial dilutions are plated onto 1/10 strength TSB. Plates are incubated for 48 hours at 37° C. and colonies are counted. For comparison, untreated fabric samples are evaluated in the same manner. Log reduction is calculated as Log₁₀(A)−Log₁₀ (B), where A is the number of colonies from the untreated fabric sample and B is the number of colonies from the 4 hour sample. Results are as indicated in Table 4.

TABLE 4

| Example No. | Log Reduction |
|---|---|
| 7 | 0.6 |
| 9 | 2.7 |

Examples 8-10 are tested in the same general manner, this time varying the exposure time from 30 to 120 minutes as indicated in Table 5. Results are as indicated in Table 5.

TABLE 5

| Example | Exposure | Log | Average |
|---|---|---|---|
| No. | Time, min | Reduction | CFU/sample |
| 8 | 120 | 1.3 | 3700 |
| 9 | 30 | 1.4 | 1500 |
| 9 | 90 | 0.6 | 1200 |
| 9 | 120 | 2.0 | 400 |
| 10 | 30 | >1.4 | <100 |
| 10 | 90 | >0.6 | <100 |
| 10 | 120 | >2.0 | <100 |

The average CFU for Example 10 at 0 exposure time is only 1300, which represents a log reduction of 0.4 despite the very minimal exposure of the bacteria to the sample.

Example 10 is taken for further testing to evaluate the laundry durability of the antimicrobial coating, with the exception that the benzoyl peroxide is replaced with an equal weight of lauroyl peroxide. Duplicate fabric samples are laundered either 0, 3, 5 or 10 times, and then tested in the same manner as describe above, with an exposure time of 24 hours. Results are as indicated in Table 6.

Fabric samples treated only with the antimicrobial coating are unable to be laundered. Those fabrics are so highly hydrophilic that they adhere to themselves and become shredded by the action of the washing machine agitator. This problem is completely resolved when the antimicrobial coating is applied over a hydrophobic coating as in Examples 7-10.

TABLE 6

| | | | Average |
|---|---|---|---|
| | No. | Log | CFU/fabric |
| Sample | Washes | Reduction | sample |
| Untreated fabric | 0 | N/A | 2.9 × 10⁸ |
| Ex. 10 | 0 | >4.6 | <100 |
| Ex. 10 | 3 | 4.6 | 6700 |
| Ex. 10 | 5 | 4.5 | 8500 |
| Ex. 10 | 10 | 4.1 | 25000 |

These results show that the antimicrobial coating retains its antimicrobial properties with only small diminution even after 10 launderings.

### EXAMPLES 11 AND 12

Coated fabric Examples 11 and 12 are produced by applying a coating composition as set forth in Table 7 to a polyester fabric, in the general manner described in Example 7-10.

TABLE 7

| Ingredient | Example 11 | Example 12 |
|---|---|---|
| Benzyldimethylstearyl | 10% | 10% |
| ammonium Chloride | | |
| 100/5 v/w | 79% | 69% |
| Pentaacrylate¹/Lauroyl | | |
| Peroxide Mixture | | |
| Thymol | 1% | 1% |
| 200 Mₙ Polyethylene | 10% | 20% |
| Glycol | | |

Antimicrobial properties of the Examples 11 and 12 are evaluated as follows:

Separate inoculums of Staphylococcus aureus 6538 and Klebsiella pneumonia are prepared. Each is plated to determine starting concentration.

The coated fabrics are cut into multiple 4.8 cm diameter circles. Enough of the circles (typically 4-6) are stacked to form test samples that can absorb 1 mL of the inoculum. Multiple test samples are produced from each coated fabric. Stacks of each of the Example 11 and 12 fabrics are inoculated with one mL of either the S. aureus or the K. pneumoniae inoculum, to produce an inoculum concentration of 1.0×10⁵ CFU. Uncoated fabrics are used as controls.

Immediately following inoculation, a portion of the control samples is harvested to determine the starting microbial concentration on the fabric.

The remaining inoculated stacks and controls are incubated at 36° C. for 24 hours and the microbial concentration is again determined. Results are as indicated in Table 8.

TABLE 8

| | | Incu- | | | |
|---|---|---|---|---|---|
| | | bation | | | |
| | | Time, | CFU/ | Percent | Log¹⁰ |
| Organism | Sample | r. | sample | Reduction¹ | Reduction¹ |
| S. aureus | Control | 0 | 6.13 × 10⁵ | N/A | N/A |
| | Control | 24 | 3.90 × 10⁶ | Increased | Increased |
| | Ex. 11 | 24 | <2* | >99.9997 | >5.49 |
| | Ex. 12 | 24 | <2* | >99.9997 | >5.49 |
| K. | Control | 0 | 6.17 × 10⁵ | N/A | N/A |
| pneumoniae | Control | 24 | 6.40 × 10⁶ | Increased | Increased |
| | Ex. 11 | 24 | 1.22 × 10³ | 99.80 | 2.70 |
| | Ex. 12 | 24 | 2.54 × 10³ | 99.59 | 2.39 |

¹Compared to Control at Time = 0. *Below the limit of detection on this test.

As the data in Table 8 shows, the applied coating provides a highly effective antibacterial effect.

What is claimed is:

1. A coating composition comprising (i) one or more free radical-polymerizable monomers wherein the at least one free radical-polymerizable monomer constitutes 35-99.5% of the combined weights of (i), (ii), (iii) and (iv), (ii) at least one free radical initiator, and 0.25 to 40% by weight based on the combined weights of (i), (ii), (iii) and (iv), of a least one of (iii) and (iv), wherein (iii) is at least one phenolic compound having a molecular weight of up to 500 g/mol and/or one or more menthol isomers and (iv) is at least one non-free radical-polymerizable ammonium compound having a molecular weight of up to 1000.

2. The coating composition of claim 1 wherein (iii) is present.

3. The coating composition of claim 2 wherein (iii) is one or more of phenol, cresol, o- and or p-phenyl phenol, stilbene, rhapontin, resveratrol, pinosylvin, caffeic acid, caffeic acid 1,1-dimethylallyl ester, chicoric acid, cinnamyl-3, 4-dihydroxy-α-cyanocinnamate, 2, 4-dihydroxycinnamic acid, ethyl 3,4-dihydroxycinnamate, chlorogenic acid, CU-CPT22 acid, butyl gallate, ethyl 3,5-dihydroxybenzoate, 3,4-dihydroxy-benzoic acid methyl ester, 2,4-dihydroxy-3,6-dimethylbenzoic acid, isopropyl 3,4,5-trihydroxybenzoate, methyl 3,5 dihydroxybenzoate) acids, cardamonin, dihydromyricetin, diosmin, epigallocatechin gallate, myricetin, myricitrin, quercetin 3-β-D-glucoside, rutin, silibinin, taxifolin, wedelolactone, baicalein, 3′,5′-dihydroxyflavone, 5,7-dihydroxy-4-phenylcoumarin, 5,7-dihydroxy-4-propylcoumarin, 5,7-dihydroxy-4-methylcoumarin, 5,8-dihydroxy-1, 4-naphthoquinone, 2,3-dichloro-5,8-dihydroxy-1, 4-naphthoquinone, thymol (2-isopropyl-5-methylphenol), carvacrol (2 isopropyl-6-methylphenol) 2-benzyl-4-chlorophenol, (5-methyl-2-(propan-2-yl)cyclohexan-1-ol)), including (+)-menthol, (+)-isomenthol, (+)-neomethyol, (+)-neoisomenthol, (−)-menthol, (−)-isomenthol, (−)-neomenthol and (−)-neoisomenthol.

4. The coating composition of claim 1 which contains 0.25 to 30% by weight of (iii), based on the combined weights of (i), (ii), (iii) and (iv).

5. The coating composition of claim 1 wherein (i) includes (i-a) at least one ammonium monomer having at least one free-radical-curable carbon-carbon double bond and at least one ammonium group.

6. The coating composition of claim 5 wherein (i-a) is an acrylate ester, methacrylate ester or acrylamide compound.

7. The coating composition of claim 6 wherein (i-a) is represented by the structure: 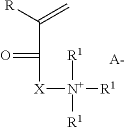
wherein R is hydrogen or methyl, X represents a linking group, each R¹ is independently hydrocarbyl having up to 18 carbon atoms, and A represents a monovalent counteranion.

8. The coating composition of claim 7 (i-a) is one or more of a 3-acrylamidopropyl trimethyl ammonium salt and an N-(2-acryloyloxyethyl)-N-benzyl-N, N-dimethylammonium salt.

9. The coating composition of claim 1 wherein (iv) is present and is one or more compounds represented by any of structures III, IV, V, VI and VII: 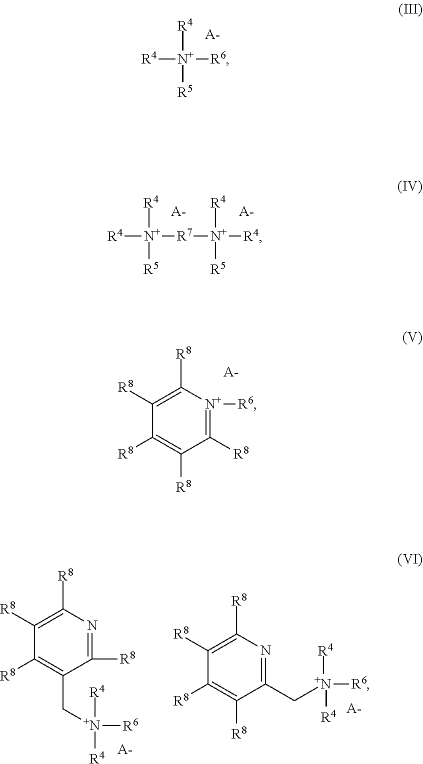
wherein:
each A represents a monovalent counteranion;
each R⁴ is independently alkyl, preferably C1-4 alkyl and most preferably methyl, provided that any two R⁴ groups may together form a divalent alkylene group;
each R⁵ is independently alkyl (preferably C1-4 alkyl, especially methyl), phenyl, substituted phenyl, benzyl or ring-substituted benzyl;
each R⁶ is an unsubstituted or substituted alkyl group having at least one unbroken chain of 8 or more, preferably 8 to 20 or 12 to 20 consecutive aliphatic carbon atoms;
R⁷ is an unsubstituted or substituted alkylene group having at least one unbroken chain of 8 or more, preferably 8 to 20 or 12 to 20 consecutive aliphatic carbon atoms; and
each R⁸ is independently hydrogen, hydroxyl substituted or unsubstituted alkyl, alkoxyl, halogen, provided that any two R⁸ groups may together form an unsubstituted or substituted divalent alkylene group.

10. The coating composition of claim 9 wherein (iv) is one or more of a C₈₋₁₈ alkyl dimethyl benzyl ammonium salt, a dialkyldimethyl ammonium salt wherein the alkyl groups have 8 to 18 carbon atoms; a benzyl dimethyl alkyl ammonium salt in which the alkyl group has 8 to 18 carbon atoms; a 1,1′-decane-1,10-diylbis(4-amino-2-methylquinolinium) decyl]-2-methyl-4-quinolin-1-iumamine salt (fluomizin) a (benzyl-dimethyl-[3-(tetradecanoylamino)propyl]azanium salt (miramistin), an N-((5-Acetoxy-4,6-dimethylpyridin-3-yl)methyl)-N,N-dimethyloctan-1-aminium salt, a N-((5-Acetoxy-4,6-dimethylpyridin-3-yl)methyl)-N,N-dimethyldodecan-1-aminium salt, aN-((5-Acetoxy-4,6-dimethylpyridin-3-yl)methyl)-N,N-dimethyloctadecan-1-aminium salt, a 5-((Octyldimethylammonio)methyl)-3-hydroxy-2,4-dimethylpyridin-1-ium salt, a 5-((Dodecyldimethylammonio)methyl)-3-hydroxy-2,4-dimethylpyridin-1-ium salt and a 5-((Dimethyl(octadecyl)ammonio)methyl)-3-hydroxy-2,4-dimethylpyridin-1-ium salt, in each case having a monovalent counteranion.

11. The coating composition of claim 1 wherein (i) includes (1-b) at least one free radical-polymerizable monomer having at least two free radical-polymerizable carbon-carbon double bonds and no ammonium group.

12. The coating composition of claim 11 wherein (1-b) is one or more of 1,4-butanediol diacrylate, 1,6-hexanediol diacrylate, 1,8-octanediol diacrylate, cyclohexane dimethanol diacrylate, trimethylolpropane triacrylate, glycerin triacrylate, pentaerythritol tetraacrylate, dipentaerythritol tetraacrylate, dipentaerythritol penatacrylate and diepentaerythritol hexacrylate.

13. The coating composition of claim 1 which further contains up to 30% by weight, based on the weight of the coating composition, of a poly(ethylene glycol) having a number average molecular weight of 180 to 3000.

14. An antimicrobial polymer produced by polymerizing a coating composition of claim 1.

15. A coated substrate comprising a substrate having on at least one surface thereof a coating of the antimicrobial polymer of claim 14.
